(19) United States
(12) Patent Application Publication
(10) Pub. No.: US 2010/0042943 A1
(43) Pub. Date: Feb. 18, 2010

(54) Method And Systems For Layered Presentation Of A Graphic Background And A Web Accessible Resource In A Browser Widget

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/189,893

(22) Filed: Aug. 12, 2008

(51) Int. Cl. G06F 3/048

(52) U.S. Cl. 715/765

(57) ABSTRACT

Methods and systems are described for layered presentation of a graphic background and a web accessible resource in a browser widget. In one aspect, a graphic background is retrieved for layered presentation in a browser widget along with a browser resource. The graphic background is presented along with the browser resource in the browser widget in a background presentation layer. A web accessible resource is presented in a web resource widget in a browser widget presentation layer on top of the background presentation layer. The browser resource is presented along with the graphic background such that it is at least partially viewable.

### BACKGROUND

A web browser is an application that enables a user to display and interact with text, images, videos, music and other information from a web accessible resource such as a Web page at a website on the World Wide Web or on a local area network. Text and images on a Web page can contain hyperlinks to other Web pages at the same or different website. Web browsers allow a user to access, quickly and easily, information provided on many Web pages at many websites via these links. Web browsers format Hypertext Markup Language (HTML) information for display, so the appearance of a Web page may differ between browsers.

Web browsers are the most commonly used type of Hypertext Transfer Protocol (HTTP) user agent. Although browsers can be used to access the World Wide Web, they can also be used to access information provided by Web servers in private networks or content in file systems. Web browsers present information in browser windows and tabs.

Browser windows and tabs include a presentation space to display information. For example, a browser window and/or browser tab can display a resource, a blank pane, or display a browser generated error or informational message. This space is wasted when it is blank.

Accordingly, there exists a need for methods, systems, and computer program products for layered presentation of a graphic background and a web accessible resource in a browser widget.

### SUMMARY

Methods and systems are described for layered presentation of a graphic background and a web accessible resource in a browser widget. In one aspect, a method is described. In the method, a graphic background is retrieved for layered presentation in a browser widget along with a browser resource. The graphic background is presented along with the browser resource in the browser widget in a background presentation layer. A web accessible resource is presented in a web resource widget in a browser widget presentation layer on top of the background presentation layer. The browser resource is presented along with the graphic background such that it is at least partially viewable.

In one aspect, a system for layered presentation of a graphic background and a web accessible resource in a browser widget is described. The system includes a background handler component. The background handler component is configured to retrieve a graphic background for layered presentation in a browser widget along with a browser resource. The system also includes a browser widget handler component. The browser widget handler component is configured to present the graphic background along with the browser resource in the browser widget in a background presentation layer. The system further includes a web resource widget handler component. The web resource widget handler component is configured to present a web accessible resource in a web resource widget in a browser widget presentation layer on top of the background presentation layer such that the browser resource presented along with the graphic background is at least partially viewable.

According to an aspect, a computer readable medium embodying a computer program, executable by a machine, for layered presentation of a graphic background and a web accessible resource in a browser widget is described. The computer program includes executable instructions for retrieving a graphic background for layered presentation in a browser widget along with a browser resource. The computer program also includes executable instructions for presenting the graphic background along with the browser resource in the browser widget in a background presentation layer. The computer program further includes executable instructions for presenting a web accessible resource in a web resource widget in a browser widget presentation layer on top of the background presentation layer such that the browser resource presented along with the graphic background is at least partially viewable.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for layered presentation of a graphic background and a web accessible resource in a browser widget according to an aspect of the subject matter described herein;

FIG. 2 is a block diagram illustrating a system for layered presentation of a graphic background and a web accessible resource in a browser widget according to another aspect of the subject matter described herein;

FIG. 3 is a block diagram illustrating an exemplary system for layered presentation of a graphic background and a web accessible resource in a browser widget according to another aspect of the subject matter described herein;

FIG. 4 is a message flow diagram illustrating a message flow in a system for layered presentation of a graphic background and a web accessible resource in a browser widget according to another aspect of the subject matter described herein;

FIG. 5 is a block diagram illustrating an exemplary user interface in a system for layered presentation of a graphic background and a web accessible resource in a browser widget according to another aspect of the subject matter described herein;

FIG. 6 is a block diagram illustrating an exemplary user interface in a system for layered presentation of a graphic background and a web accessible resource in a browser widget according to another aspect of the subject matter described herein; and

FIG. 7 is a block diagram illustrating an exemplary user interface in a system for layered presentation of a graphic background and a web accessible resource in a browser widget according to another aspect of the subject matter described herein.

### DETAILED DESCRIPTION

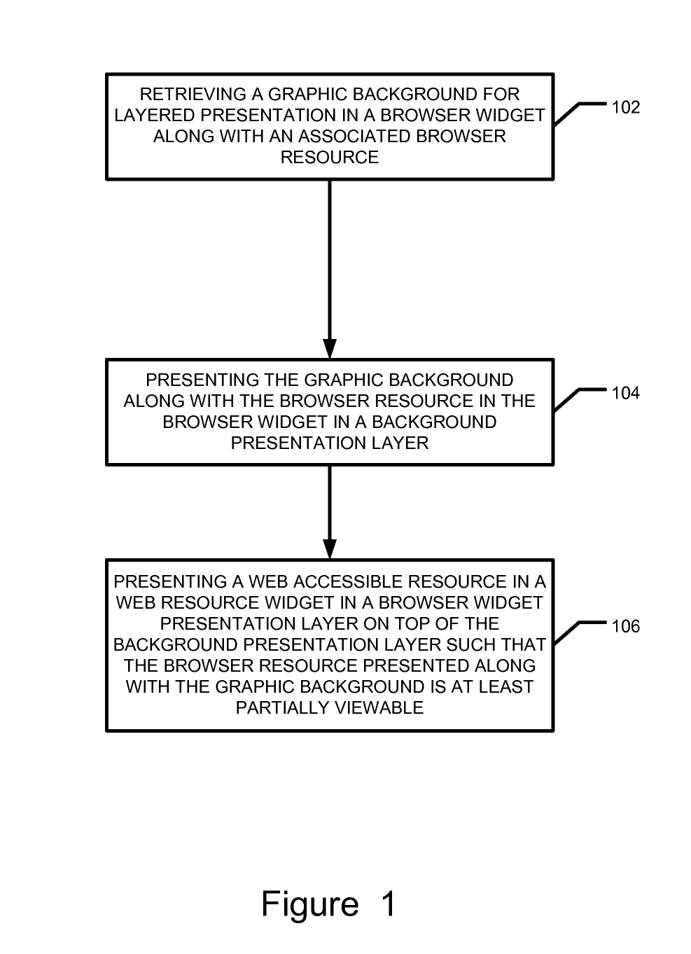

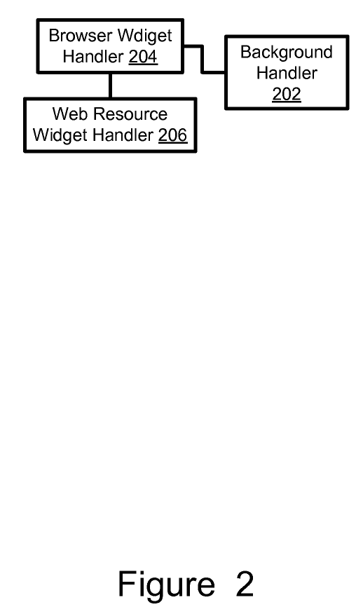

FIG. 1 is a flow diagram illustrating a method for layered presentation of a graphic background and a web accessible resource in a browser widget according to an exemplary aspect of the subject matter described herein. FIG. 2 is a block diagram illustrating a system for layered presentation of a graphic background and a web accessible resource in a browser widget according to another exemplary aspect of the subject matter described herein. The method illustrated in FIG. 1 can be carried out by, for example, some or all of the components illustrated in the exemplary system of FIG. 2.

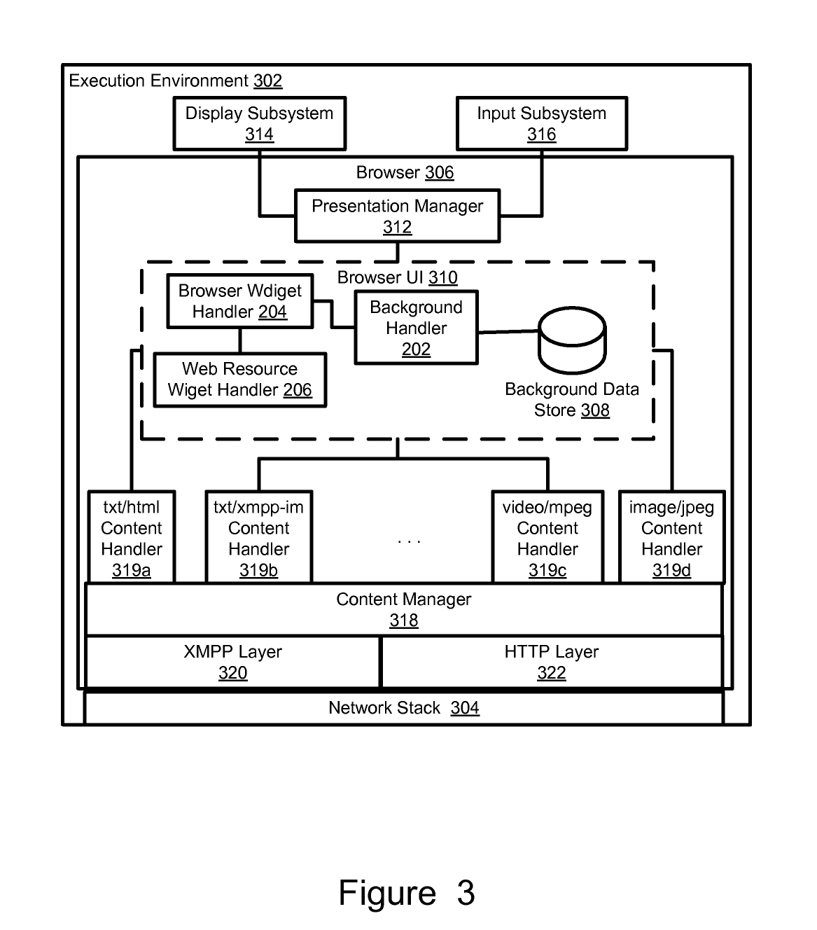

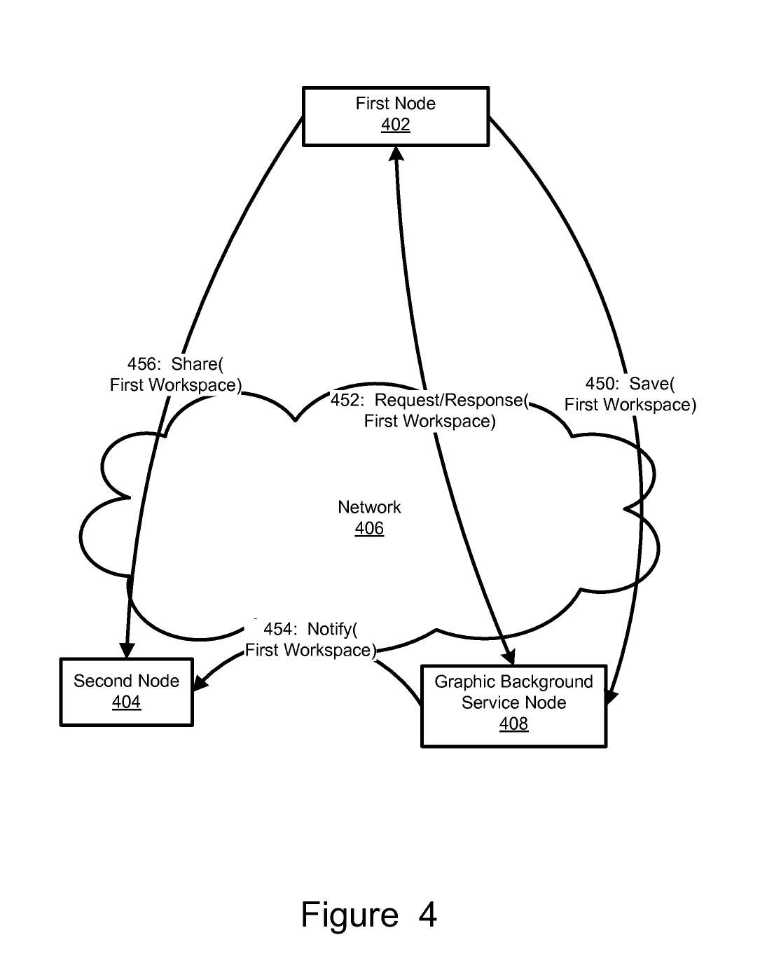

The components illustrated in FIG. 2 can be adapted for performing the method illustrated in FIG. 1 in a number of execution environments, such as an exemplary execution environment 302 provided by the components illustrated in FIG. 3. Additionally or alternatively, an execution environment can be configured for hosting the components in FIG. 2 or analogous arrangements of components configured for performing the method illustrated in FIG. 1. An execution environment can be hosted by a node and/or can be hosted by multiple nodes as in a distributed execution environment. For example, referring to FIG. 4, a first node 402 can be configured to provide the execution environment 302 adapted for supporting the operation of the components in FIG. 2.

An exemplary execution environment can include a variety of components, including, but not limited to, memory for storing components and an instruction processing component, such as processor and/or a digital signal processor (DSP), for processing instructions and any data associated with the operation of the components such as the components illustrated in FIG. 2. The components illustrated in FIG. 2 and functionally analogous arrangements of components each can require additional hardware and/or software subsystems according to their particular operational requirements.

For example, a network subsystem, such as a network stack 304 illustrated in FIG. 3, can be included in the execution environment 302 for communicating with a component in a remote device, such as a second node 404 over a network 406 as will be described below. An operating system, persistent data storage subsystem, memory management subsystem, and/or a process scheduler are other examples of components that can be required for various adaptations of the components in FIG. 2 and its functional analogs for performing the method in FIG. 1.

With reference to FIG. 1, in block 102 a graphic background is retrieved for layered presentation in a browser widget along with a browser resource. Accordingly, a system for layered presentation of a graphic background and a web accessible resource in a browser widget includes means for retrieving a graphic background for layered presentation in a browser widget along with a browser resource. For example, as illustrated in FIG. 2, a background handler component 202 is configured to retrieve a graphic background for layered presentation in a browser widget along with a browser resource.

As illustrated in FIG. 3 the background handler component 202 and the remaining components illustrated in FIG. 2 can, according to an aspect, operate within a browser 306 or a browser plug-in (not illustrated). The graphic background can include digital image data, such as in a digital photograph, drawing, and/or executable instructions for generating a graphical representation. Further, the graphic background can identify image data for presentation including at least one of an image and a video stream. In another aspect, the graphic background can be a representation of an active desktop and the browser resource can be a representation of a local desktop resource. For example, the background handler component 202 can be configured to retrieve a representation of an active desktop as the graphic background, wherein the browser resource is a representation of a local desktop resource. Local applications can be browser resources, and can be presented along with the graphic background that is presented as an active desktop.

According to an aspect, the graphic background can be retrieved from a client including the browser widget. For example, the background handler component 202 can be configured to retrieve the graphic background from a client including the browser widget. The client including the browser widget can be hosted by the first node 402, and the graphic background can be included on the first node 402 for retrieval. The graphic background can be stored on the first node 402 and/or generated by the first node 402. The background handler background handler component 202 can retrieve a background record identifying the graphic background from a background data store 308 as illustrated in FIG. 3. In an aspect where the graphic background can be retrieved from a client including the browser widget, the background data store 308 can be included on the first node 402.

The background handler component 202 can retrieve the graphic background in response to an input received from a user. Alternatively or additionally, the graphic background can be retrieved by the background handler component 202 based on a location in a region of a node and/or a user interacting with a user interface provided by the execution environment 302 hosting the background handler component 202. In another aspect, the graphic background can be retrieved based on an attribute associated with the browser widget. For example, the background handler component 202 can be configured to retrieve the graphic background based on an attribute associated with the browser widget. Further, the background handler component 202 can retrieve a graphic background based on any attribute accessible to a hosting execution environment including a task to be performed (and/or being performed), a network domain including a node hosting a background handler component 202, an identity or other characteristic of at least one of a user, a security setting, and a browser resource. A graphic background can be retrieved based on the source of a configuration or attribute associated with the browser widget and/or the execution environment. A graphic background can be retrieved based on any available attribute.

As stated above, the graphic background is retrieved for layered presentation in a browser widget along with a browser resource. A browser resource can be any resource included in a particular browser and/or a browser's configuration. Configuration information can be supplied by and/or identified by any of user input, a server such as a DHCP server, a domain server, a gateway server for a subnet, and the like. Examples of browser resources can include text strings, fonts, icons and images, video, audio, and information included and/or associated with graphic backgrounds.

A browser resource can be associated with metadata of a web accessible resource. For example, the browser resource can be an icon and/or text representing the resource. The browser resource can be associated with metadata such as a URL for accessing the resource. Thus, a selection of the browser resource can result in accessing the resource. This process is described more fully below.

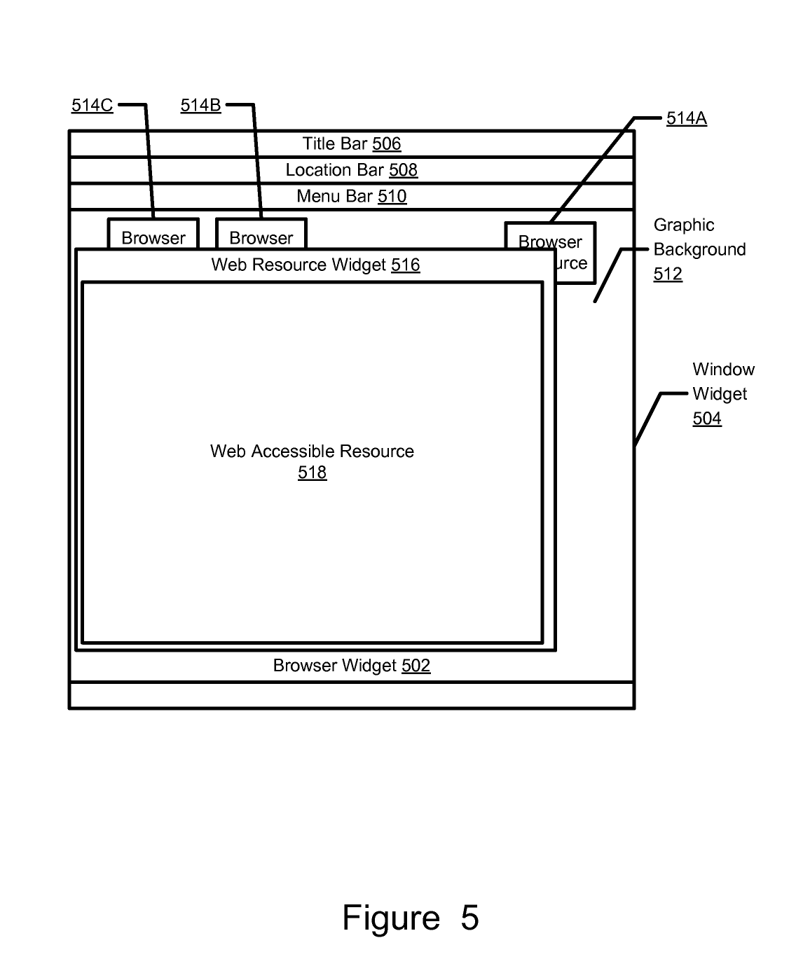

FIG. 5 illustrates an exemplary user interface of a browser, such as the browser 306 operating in an execution environment, such as the execution environment 302 provided by the first node 402. The browser user interface as illustrated includes a browser widget 502. The browser widget 502 in FIG. 5 is included in a window widget 504. The window widget 504 also includes a title bar widget 506 that can present a title associated with the browser and/or a web accessible resource. The window widget 504 also includes a location bar widget 508 that can present location information associated with a web accessible resource, such as a Uniform Resource Locator (URL) associated with the web accessible resource. The window widget 504 also includes a menu bar widget 510 that can present menu options, such as a file menu include file commands such as save, print, etc. A graphic background 512 is illustrated as presented in the browser widget 502 along with a browser resource 514.

According to an aspect, the graphic background 512 can change size when the size of the browser widget 502 changes. The graphic background 512 can be at partially to see an object beneath/behind the graphic background 512.

In another aspect, at least one of the graphic background 512 and the browser resource 514 for presentation along with the graphic background 512 can be determined based on a requested web accessible resource. For example, the background handler component 202 can be configured to determine at least one of the graphic background 512 and the browser resource 514 for presentation along with the graphic background 512 based on a requested web accessible resource. Further, the graphic background 512 can be determined based on metadata associated with the requested web accessible resource. In another aspect, the browser resource 514 can be determined based on metadata associated with the requested web accessible resource. For example, the background handler component 202 can be configured to determine at least one of the graphic background 512 and the browser resource 514 based on metadata associated with the requested web accessible resource.

In another aspect, the web accessible resource can be received from a first resource provider, wherein the graphic background is retrieved from a second resource provider. The graphic background 512 can be from a resource provider other than the web accessible resource. For example, as illustrated in FIG. 4, a graphic background service node 408 can provide the graphic background 512. A service provider (not illustrated) provides the web accessible content. Accordingly, the graphic background 512 can be provided by the graphic background service node 408 (the first resource provider) and the web accessible resource can be provided by the service provider (the second resource provider).

Returning to FIG. 1, in block 104 the graphic background is presented along with the browser resource in the browser widget in a background presentation layer. Accordingly, a system for layered presentation of a graphic background and a web accessible resource in a browser widget includes means for presenting the graphic background along with the browser resource in the browser widget in a background presentation layer. For example, as illustrated in FIG. 2, a browser widget handler component 204 is configured to present the graphic background along with the browser resource in the browser widget in a background presentation layer.

FIG. 2 illustrates the browser widget handler component 204 configured for presenting the graphic background including the browser resource in the browser widget in a background layer. The browser widget handler component 204 can receive the graphic background retrieved by the background handler component 202. The browser resource can additionally be received from the background handler component 202 or alternatively the browser widget handler component 204 can access the browser resource based on information included in and/or provided with the graphic background.

As illustrated in FIG. 3 and FIG. 5, the browser widget handler component 204 can be configured to present the graphic background 512 and at least one browser resource 514, such as a first browser resource 514A, a second browser resource 514B, and a third browser resource 514C. The browser resource 514 and the graphic background 512 can be displayed in a presentation space of the browser widget 502.

The browser widget handler component 204 can be included in a browser user interface 310 subsystem. The browser widget handler component 204 can be configured to interoperate with a presentation manger 312 for instructing a display subsystem 314 included in the execution environment 302 and operatively coupled with a display device (not illustrated) to present the browser widget 502 including the graphic background 512 and the browser resource 514 on the display device. Other widgets including the title bar 506, location bar 508, and menu bar 510 are presented on the display device in similar manner by the browser user interface (UI) subsystem by widget handlers corresponding to each of the other widgets interoperating along with the browser UI 310 with the presentation manager 312.

The display subsystem 314, as supported by the presentation manager 312, can provide for a layered presentation. Layers can have an order determining whether each layer is in the foreground or the background with respect to another layer. The order is referred to as a z-order. A z-order is an ordering of overlapping two-dimensional objects, such as widget in a Graphical User Interface (GUI). GUIs can allow presented objects to overlap, so that one object hides or is in front of or on top of part or all of another. When two objects overlap, their Z-order determines which one appears on top or in front of the other. In another aspect, the graphic background 512 can be associated with a lowest z-order, wherein the graphic background 512 is presented behind the web accessible resource based on the z-order. For example, the browser widget handler component 204 can be configured to present the graphic background 512 behind a web accessible resource 518 based on a lower z-order associated with the graphic background 512 than associated with the web accessible resource 518.

The browser widget handler component 204 can be configured to present the graphic background 512 in a background layer with respect to the presentation of any web accessible resource such as web page. Each browser resource 514a-c can be presented as a portion of the graphic background 512 and/or can be presented in a presentation layer in the foreground with respect to the background presentation layer. When presented in a presentation layer different than a resource presentation layer, a browser resource 514 is presented in a presentation layer in the background with respect to the resource presentation layer. Alternatively or additionally, a browser resource 514 can be presented in the same layer as the resource presentation layer of a web accessible resource. In this case, the web accessible resource when presented can be displayed in the foreground with respect to the browser resource 514 within the resource presentation layer that includes both.

According to an aspect, the browser resource 514 can be associated with a location on the graphic background 512, wherein the location is at least one of persistent and independent of the graphic background 512. For example, the browser widget handler component 204 is configured to present the browser resource 514 in a location associated with the graphic background 512, wherein the location is at least one of persistent and independent of the graphic background 512. The browser resource 514 can be associated with a location on the graphic background 512 that is persistent. The association of the browser resource with a location on the graphic background 512 can be fixed even if the content associated with the location changes. Alternatively, the browser resource 514 can be associated with a location in the browser widget 502 independent of the graphic background 512. That is, the browser resource 514 can be located in a location in the presentation space of the browser widget 502 without regard to the graphic background 512.

In another aspect, the graphic background 512 and the browser resource 514 can be presented independent of a network request to a service provider. For example, the browser widget handler component 204 can be configured to present the graphic background 512 and the browser resource 514 independent of a network request to a service provider. For example, the graphic background 512 and the browser resource 514 can be presented as home page of the browser widget 502 prior to making a network request.

Returning to FIG. 1, in block 106 a web accessible resource is presented in a web resource widget in a web resource widget presentation layer on top of the background presentation layer. The web accessible resource is presented such that the browser resource presented along with the graphic background is at least partially viewable. Accordingly, a system for layered presentation of a graphic background and a web accessible resource in a browser widget includes means for presenting a web accessible resource in a web resource widget in a web resource widget presentation layer of the browser widget on top of the background presentation layer such that the browser resource presented along with the graphic background is at least partially viewable. For example, as illustrated in FIG. 2, a web resource widget handler component 206 is configured to present a web accessible resource in a web resource widget in a browser widget presentation layer on top of the background presentation layer such that the browser resource presented along with the graphic background is at least partially viewable.

The web resource presentation layer is in the foreground with respect to the background presentation layer and with respect to the presentation of any browser resource. As a result the web accessible resource is presented on top, also said to be in front of, the graphic background presented in the background presentation layer. When the web resource widget is not maximized in the presentation space of the browser widget and properly positioned, at least a portion of the browser resource is viewable.

As illustrated in FIG. 3, the web resource widget handler component 206 can be invoked by the browser widget handler component 204 to present a web resource widget 516 as illustrated in FIG. 5 in the browser widget 502 in front of the graphic background 512 and the browser resources 514. The web resource widget handler component 206 and the browser UI 310 interoperate with the presentation manager 312 in a manner analogous to that described above for the browser widget handler component 204 for presenting the web resource widget 516 and visual presentation of the web accessible resource 518. The web accessible resource 518 can be a web page and/or a media type, such as a video, presented by a plug-in in a presentation space provided of the web resource widget 516. For example, various content handlers 319 for presenting a variety of resources are illustrated in FIG. 3. These can include a txt/html content handler 319a for presenting HTML resources, a txt/xmpp-im content handler 319b for presenting instant messaging and/or presence resources, a video/mpeg content handler 319c for presenting video resources, and an image/jpeg content handler 319d for presenting image resources.

In FIG. 5, as described above, the web resource widget 516 including a presentation of the web accessible resource 518 can be presented in a foreground layer in a portion of the browser widget 502 allowing the graphic background 512 and one or more of the browser resources 514a-c to be visible. As described above, the browser resources 514a-c can be presented as representations of web accessible resources, local resources such as applications, browser configuration options and bookmarks. Alternatively or additionally, the presented browser resources 514 can be icons, image thumbnails, graphic drawings, and/or text that are provided for accessing an associated web accessible resource, local resource, and/or browser feature/function.

For example, the web resource widget handler component 206 can be configured to minimize the web resource widget 516 to a browser resource 514 presented in the graphic background 512 in response to a detected input received via an input subsystem 316 for minimizing a web resource widget. An input corresponding to a browser resource 514, such as a mouse click received when a mouse pointer is in the presentation region of the browser resource 514, can be received in correspondence with the browser widget 502 by the browser widget handler component 204 from the presentation manager 312 configured for routing input received from the input subsystem 316. The browser widget 502 can be configured to call the corresponding instance of a web resource widget handler component 206 with a command to restore the presentation of the web resource widget 516 from its minimized state. Further, according to an aspect, in response to receiving input associated with the browser resource 514, a web accessible resource is requested for presentation, wherein the web accessible resource is associated with the browser resource. For example, the web resource widget handler component 206 component can be configured to request, in response to receiving input associated with the browser resource 514, a web accessible resource associated with the browser resource for presentation.

The web resource widget 516 can be presented in a maximized state by the web resource widget handler component 206 configured to support this mode of presentation. The browser widget handler component 204 and various instances of web resource widget handler components 206 can be configured to allow a web resource widget to be moved within the presentation space of the browser widget 502. Alternatively or additionally, the browser widget handler component 204 can be configured to allow a browser resource 514 to be moved within the presentation space, copy/moved between various graphic backgrounds presented in corresponding browser widgets, deleted from a graphic background, and/or allow attributes other than a presentation location of a browser resource to be modified. Attributes of a browser resource can include a font, color, image data for presenting, a size, and/or a command or action executable in association with a corresponding input received in association with a browser resource. Browser resources 514a-c can be visual representations provided for each web accessible resource. Alternatively or additionally, a portion of a graphic background can serve as a visual representation of a web accessible resource. If the background is an image or a graphic with visible objects, then objects in the background can be associated with a web resource by a user. Alternatively or additionally, icons or other visual representations can be overlaid on the background.

An input can be received that is defined to indicate a graphic background 512 is to be stored. The input can be provided to the browser widget handler component 204. The browser widget handler component 204 can interoperate with the background handler component 202 providing the graphic background 512 and/or updates to the graphic background 512 to the background handler component 202 for storing in the background data store 308. The browser widget handler component 204 can be configured to provide browser resource information for the browser resources 514 presented in the graphic background 512 for associating with the graphic background 512. Similarly, web accessible resource information from any web resource widget handler components associated with the browser widget handler component 502 can be provided by each web resource widget handler component, such as the web resource widget handler component 206, for storage in association with the stored graphic background 512. The browser resource information, web accessible resource information, and other attributes can be stored in the graphic background 512 and/or external to but associated with the graphic background 512.

Stored graphic backgrounds and their associated background information can be named and/or provided with other types of identifiers for identifying when locating and managing graphic backgrounds. Background information can include and/or be associated with information indicating when a graphic background and associated background information is to be presented. Such information as described above can include task information, user information, security information, and the like.

A graphic background and associated background information can be retrieved for presentation when indicated by a user and/or automatically when a condition associated with the graphic background and background information is met.

A graphic background can be shared. For example, as illustrated in FIG. 4, a graphic background stored in the first node 402 can be transmitted in a message or a series of message via the network 406 to a node, such as the graphic background service node 408. The graphic background service node 408 can be configured for sharing the identifiable graphic background with users of other nodes such as the second node 404. As illustrated in FIG. 3, the background handler component 202 can be configured for interoperating with a content manager 318 for sending a message for sharing a graphic background. The content manager 318 can be configured for sending and/or receiving a message for sharing a graphic background via the network stack 304 operatively coupled to the network 406. The content manager 318 can send and/or receive a message for sharing a graphic background via an application protocol layer such as an Extensible Messaging and Presence Protocol (XMPP) layer 320 and/or a HTTP layer 322.

A save message 450 is illustrated in FIG. 4 for sending an identifiable graphic background and associated background information to the graphic background service node 408. A request/response message pair 452 is also illustrated in FIG. 4. The first node 402 can send a request message portion of request/response message pair 452 identifying a graphic background and associated background information to the graphic background service node 408. The service in the service node 408 can send a response message portion of request/response message pair 452 including information for accessing the identified graphic background and associated background information to the first node 402 for presentation in a browser widget. Any browser resources and/or web accessible resources identified in the background information can be included in the background information and/or accessed based on access identifiers, such as URIs, from a resource provider. The request message portion of request/response message pair 452 can identify a condition and the response can enable access to one or more graphic backgrounds and associated background information associated with the condition.

A notify message 454 is illustrated as an asynchronous message sent from the graphic background service node 408 to the second node 404. An asynchronous message can be formatted according to a publish-subscribe protocol, such as a presence protocol. A presence protocol is a specialized publish-subscribe protocol including a status field. The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society. While the various presence aware IM applications described above may user proprietary architectures and protocols to implement their presence service components, each of the applications use presence architectures and protocols that are consistent with the presence model and protocols described in RFC 2778 and RFC 2779 in terms of features and function.

The notify message 454 can include graphic background information allowing access by the second node 404 to an identified graphic background and associated background information for use by a browsing client operating in an execution environment provided by the second node 404. The notify message 454 can be an event message or can be a notification message sent in response to a publish message. The save message 450 can be a publish message. The notify message can be sent as directed by the publish message, for example, or can be sent in response to a tuple update resulting from the publish message. The tuple can include a status of a principal such as a user of one of the nodes or a status of one of the nodes or a component of one of the nodes. The tuple can be a graphic background information tuple. The graphic background information tuple can be used to synchronize the information presented in corresponding browser widgets presented in two or more nodes. The synchronization can be one-way or two-way synchronization using one or more graphic background information tuples.

Alternatively, the first node 402 can share the graphic background directly with the second node 404. The direct sharing can be accomplished by a share message 456. The share message 456 can include graphic background information allowing access by the second node 404 to an identified graphic background and associated background information for use by a browsing client operating in an execution environment provided by the second node 404.

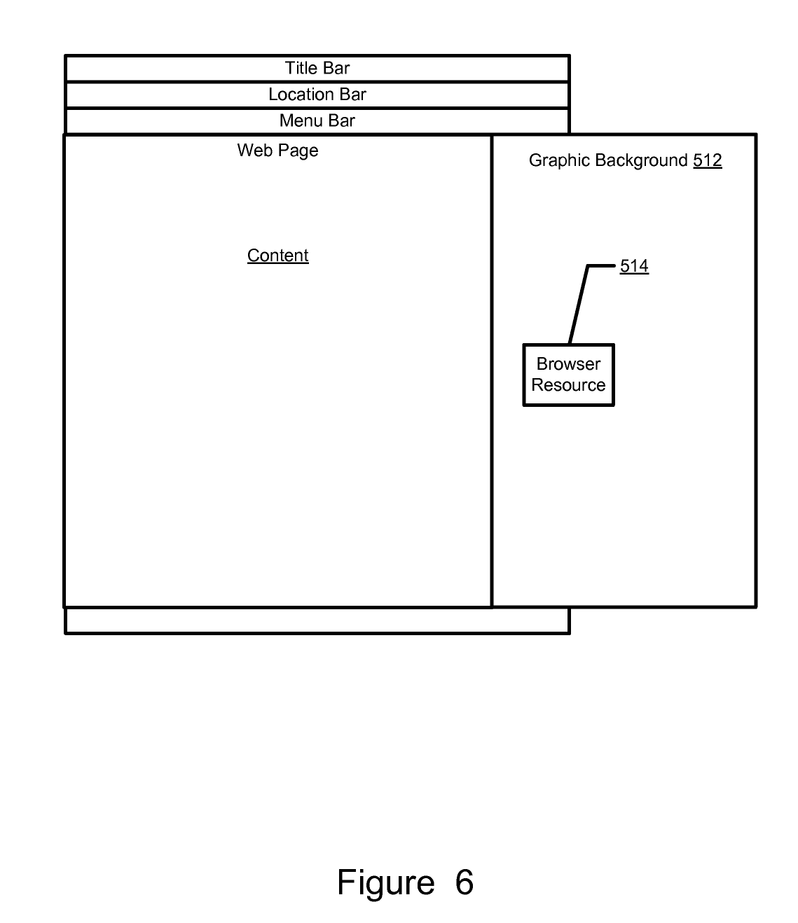

According to an aspect, FIG. 6 illustrates an exemplary GUI where the graphic background 512 is presented in a widget that is enabled to slide-out from the displayed resource in response to an input such as a position of a mouse pointer.

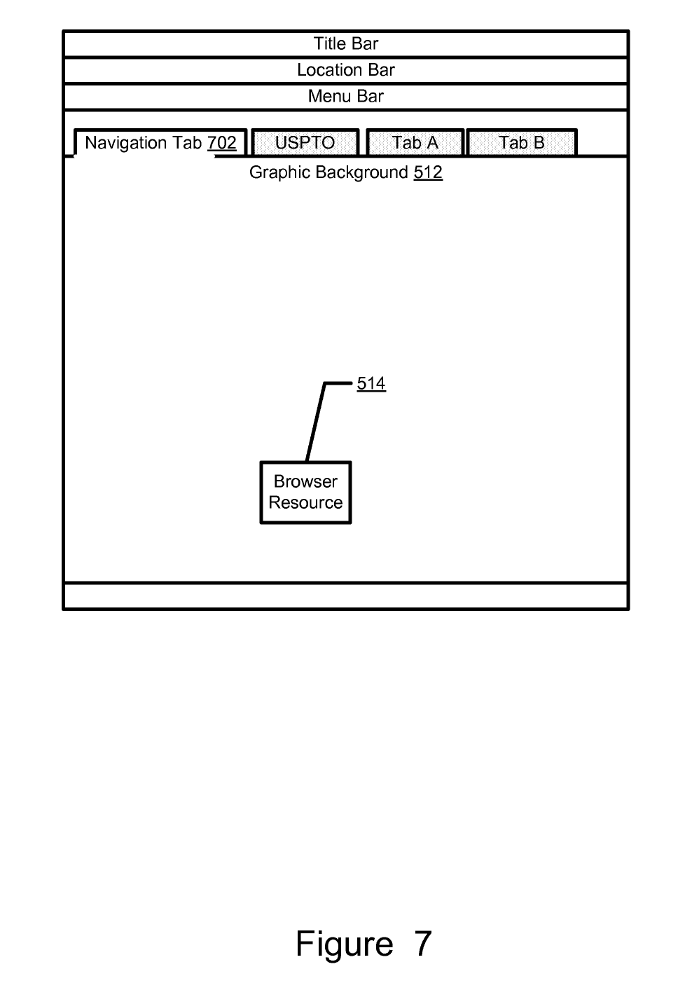

According to an aspect, FIG. 7 illustrates an exemplary GUI where a tab is designated as a background tab illustrated as a navigation tab 702. Browser resources 514a-c can be selected for presenting a portion such as a preview of an associated web accessible resource. The web accessible resource can optionally be opened in another tab 704 with a different graphic background. In this way graphic backgrounds can be nested. Thus, a browser resource presented on a background can be associated with a second background that can be presented in front of the parent background and/or in a separate browser widget such as a page or tab. According to such an aspect, a web accessible resource can be retrieved in response to an input received in association with a browser resource presented in a second browser widget. Further, a web accessible resource can be retrieved in response to an input moving the browser resource to a second browser widget, an application widget, a desktop.

It should be understood that the various components illustrated in the various block diagrams represent logical components that are configured to perform the functionality described herein and may be implemented in software, hardware, or a combination of the two, in connection with an instruction execution machine, apparatus, or device, such as a computer-based or processor-containing machine, apparatus, or device. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein can be embodied in executable instructions stored in a computer readable medium for use by or in connection with an instruction execution machine, system, apparatus, or device, such as a computer-based or processor-containing machine, system, apparatus, or device. As used here, a “computer readable medium” can include one or more of any suitable media for storing the executable instructions of a computer program in one or more of an electronic, magnetic, optical, electromagnetic, and infrared form, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein can be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for layered presentation of a graphic background and a web accessible resource in a browser widget, the method comprising:
retrieving a graphic background for layered presentation in a browser widget along with a browser resource;
presenting the graphic background along with the browser resource in the browser widget in a background presentation layer; and
presenting a web accessible resource in a web resource widget in a browser widget presentation layer on top of the background presentation layer such that the browser resource presented along with the graphic background is at least partially viewable.

2. The method of claim 1 wherein the graphic background is retrieved from a client including the browser widget.

3. The method of claim 1 wherein the graphic background and the browser resource are presented independent of a network request to a service provider.

4. The method of claim 1 further comprising receiving the web accessible resource from a first resource provider, wherein the graphic background is retrieved from a second resource provider.

5. The method of claim 1 wherein retrieving the graphic background is based on an attribute associated with the browser widget.

6. The method of claim 1 wherein the graphic background is a representation of an active desktop and the browser resource is a representation of a local desktop resource.

7. The method of claim 1 further comprising determining at least one of the graphic background and the browser resource for presentation along with the graphic background based on a requested web accessible resource.

8. The method of claim 7 wherein at least one of the graphic background and the browser resource is determined based on metadata associated with the requested web accessible resource

9. The method of claim 1 wherein the browser resource is associated with a location on the graphic background, wherein the location is at least one of persistent and independent of the graphic background.

10. The method of claim 1 wherein the graphic background and the web resource widget each have an associated z-order, wherein the graphic background is presented behind the web resource based on the graphic background having a lower z-order than the web resource widget.

11. The method of claim 1 further comprising requesting, in response to receiving input associated with the browser resource, a web accessible resource for presentation, wherein the web accessible resource is associated with the browser resource.

12. A system for layered presentation of a graphic background and a web accessible resource in a browser widget, the system comprising:
means for retrieving a graphic background for layered presentation in a browser widget along with a browser resource;
means for presenting the graphic background along with the browser resource in the browser widget in a background presentation layer; and
means for presenting a web accessible resource in a web resource widget in a browser widget presentation layer on top of the background presentation layer such that the browser resource presented along with the graphic background is at least partially viewable.

13. A system for layered presentation of a graphic background and a web accessible resource in a browser widget, the system comprising:
a background handler component configured to retrieve a graphic background for layered presentation in a browser widget along with a browser resource;
a browser widget handler component configured to present the graphic background along with the browser resource in the browser widget in a background presentation layer; and
a web resource widget handler component configured to present a web accessible resource in a web resource widget in a browser widget presentation layer on top of the background presentation layer such that the browser resource presented along with the graphic background is at least partially viewable.

14. The system of claim 13 wherein the background handler component is configured to retrieve the graphic background from a client including the browser widget.

15. The system of claim 13 wherein the browser widget handler component is configured to present the graphic background and the browser resource independent of a network request to a service provider.

16. The system of claim 13 wherein the web accessible resource is received from a first resource provider, and the background handler component is configured to retrieve the graphic background from a second resource provider.

17. The system of claim 13 wherein the background handler component is configured to retrieve the graphic background based on an attribute associated with the browser widget.

18. The system of claim 13 wherein the background handler component is configured to retrieve a representation of an active desktop as the graphic background, wherein the browser resource is a representation of a local desktop resource.

19. The system of claim 13 wherein the background handler component is configured to determine at least one of the graphic background and the browser resource for presentation along with the graphic background based on a requested web accessible resource.

20. The system of claim 19 wherein the background handler component is configured to determine at least one of the graphic background and the browser resource based on metadata associated with the requested web accessible resource

21. The system of claim 13 wherein the browser widget handler component is configured to present the browser resource in a location associated with the graphic background, wherein the location is at least one of persistent and independent of the graphic background.

22. The system of claim 13 wherein the browser widget handler component is configured to present the graphic background behind the web resource based on the graphic background having an associated z-order lower than a z-order associated with the web resource widget.

23. The system of claim 13 wherein the web resource widget handler component configured to request, in response to receiving input associated with the browser resource, a web accessible resource, associated with the browser resource, for presentation.

24. A computer readable medium embodying a computer program, executable by a machine, for layered presentation of a graphic background and a web accessible resource in a browser widget, the computer program comprising executable instructions for:
retrieving a graphic background for layered presentation in a browser widget along with a browser resource;
presenting the graphic background along with the browser resource in the browser widget in a background presentation layer; and
presenting a web accessible resource in a web resource widget in a browser widget presentation layer on top of the background presentation layer such that the browser resource presented along with the graphic background is at least partially viewable.
